(19) United States
(12) Patent Application Publication
(10) Pub. No.: US 2011/0200337 A1
(43) Pub. Date: Aug. 18, 2011

(54) MODULATION SCHEME

(76) Inventors: Johnny Karout, Goteborg (SE); Krzysztof Szczerba, Goteborg (SE); Erik Agrell, Goteborg (SE)

(21) Appl. No.: 12/976,188

(22) Filed: Dec. 22, 2010

Related U.S. Application Data
(60) Provisional application No. 61/304,459, filed on Feb. 14, 2010.

(51) Int. Cl. H04B 10/12; H04B 10/04

(52) U.S. Cl. 398/141; 398/183; 398/189

(57) ABSTRACT

The present invention relates to a method for modulation, the method comprising: receiving a data stream; forming a modulated electrical signal from the data stream by using a plurality of data signals, each of the plurality of data signals representing at least one data bit of the data stream, wherein one of the plurality of data signals is a zero signal and wherein the remainder of the plurality of data signals comprises periodic, positive non-zero subcarrier signals and/or non-periodic signals with a positive DC-level; and providing the modulated electrical signal representing the data stream.

The present invention also relates to a device performing the modulation method and to a system incorporating such a device.

### FIELD OF THE INVENTION

The invention relates to a method for modulation. More specifically, the invention relates to a method for providing a modulated electrical signal. The present invention also relates to a device performing the modulation method and to a system incorporating such a device.

### TECHNICAL BACKGROUND

Multilevel modulation with information encoded onto the amplitude and phase of an electromagnetic carrier signal has attracted significant research interest in efforts to increase transmission rate and spectral efficiency. However, the enabling technology for such modulation schemes is often not feasible for short-haul optical applications such as local area networks, data centers, and computer interconnects, where the overall cost and complexity has to be kept down. Intensity modulation and direct detection (IMDD) is commonly used in short haul applications. In such a system, the information is modulated onto the intensity of the optical carrier using a laser diode and the receiver detects the instantaneous power of the received signal using a photodiode, thereby only using the intensity of the signal to transmit information.

In a system using an intensity modulated subcarrier signal, one challenge is to select a modulation format which offers a good trade-off between spectral efficiency and power efficiency as well as having low peak amplitudes in the generated electrical waveform, as high amplitude peaks may cause the electro-optic components (such as laser diodes and receivers) to operate in a nonlinear fashion.

### SUMMARY OF THE INVENTION

In view of the aforementioned, it is an object of the present invention to provide an improved modulation method, and in particular a modulation method suitable for subcarrier modulation in a system transmitting an electromagnetic carrier signal.

According to an aspect of the invention, the aforementioned object is achieved by a method for modulation, the method comprising: receiving a data stream; forming a modulated electrical signal from the data stream by using a plurality of data signals, each of the plurality of data signals representing at least one data bit of the data stream, wherein one of the plurality of data signals is a zero signal and the remainder of the plurality of data signals comprises periodic, positive non-zero subcarrier signals; and providing the modulated electrical signal representing the data stream.

The term “zero signal” should in the present context be understood as a non-periodic signal having constant amplitude and the term “non-zero subcarrier signal” should be understood as a periodic subcarrier signal varying in amplitude with a certain frequency and phase. Furthermore, the zero signal may have a value slightly different from zero, it may also have a small periodic component. The general concept of the present modulation method is still valid for a signal deviating slightly from the zero signal as described above. However, the overall performance of the modulation method would be significantly degraded if the properties of the zero signal are significantly changed.

The present invention is based on the realization that a modulation scheme using a zero signal and a number of phase shifted subcarrier signals offers a better tradeoff between spectral efficiency and power efficiency (understood as sensitivity) in an intensity modulated transmission system compared to known modulation schemes such as subcarrier phase shift keying (PSK), subcarrier quadrature amplitude modulation (QAM) and on-off keying (OOK). The modulation scheme according to the present invention can be regarded as a combination between OOK and PSK. The present modulation scheme encodes information into the phase of a subcarrier signal in the same manner as in PSK modulation, and it uses a zero signal containing information similar to OOK modulation. In conventional phase shift keying modulation, the phase of the carrier signal is shifted with regard to a reference signal. As the range of the carrier phase is zero to 2π, the phase shift depends on the number of modulating signals, M, as 2π/M. By increasing the number of modulating signals, a higher bit rate can be achieved but at the same time the bit error rate (BER) for a given signal-to-noise ratio (SNR) increases. On-off keying is the simplest form of intensity modulation as it is only the presence or absence of a carrier signal representing digital one and zero, respectively.

Furthermore, bit error rates of the present modulation scheme are comparable to known modulation formats. By using the zero signal as a data signal, the dimension of a conventional subcarrier PSK modulation scheme may be extended thereby achieving improved power efficiency.

The modulation scheme according to the invention applies to any electromagnetic carrier whose amplitude but not phase can be modulated and detected. The absence of carrier phase information in a transmission system may be the result of limitations in the transmitter, channel, receiver or any combination thereof.

It should be noted that the remainder of the plurality of data signals alternatively or additionally may comprise non-periodic signals with a positive DC-level.

According to an embodiment of the invention, the plurality of non-zero signals may advantageously comprise three subcarrier signals wherein the different phases of the signals are equidistantly spaced. By having a set of three periodic signals with the same phase-distance between them, the distance between the corresponding constellation points in Euclidian space is equal. Thereby, a good trade-off between spectral efficiency and power efficiency can be achieved.

Furthermore, the three non-zero subcarrier signals together with the zero signal may advantageously be used as a basis set used for further extension of the modulation format using additional periodic, positive, non-zero signals.

In one embodiment of the invention, the amplitude may advantageously be the same for all non-zero subcarrier signals. By using the same amplitude for all non-zero subcarrier signals, it is possible to achieve optimal energy efficiency.

According to one embodiment of the invention, the three subcarrier signals being equidistant in phase and having the same amplitude may all have the same DC-level. The term “DC-level” should in the present context be understood as the mean amplitude value of a periodic signal.

In another embodiment of the invention, the plurality of data signals may advantageously comprise at least one non-periodic signal having a positive DC-level. Using a non-periodic signal with a substantially constant positive DC-level in addition to the non-periodic zero-signal may be a preferable way to further extend the modulation method with additional data signals.

According to another embodiment of the invention, at least two of the non-zero subcarrier signals may have different DC levels. Additional subcarrier signals may used to extend the modulation format, such signals may then differ in DC-level with respect to each other and with respect to the previously mentioned signals suggested to form a basis set of signals for the proposed modulation format.

In an embodiment of the invention, the method may further comprise modulating a light generating device using the modulated electrical signal. By using the modulated electrical signal according to the present invention to modulate a light generating device, such a light generating device can be incorporated as a transmitter in optical communication system based on intensity modulation and direct detection (IMDD). The present modulation method also fulfills the required normegativity constraint of an optical channel. In an IMDD system, the average intensity of the light of the transmitter is controlled by controlling the electrical signal biasing the light generating device. The optical signal is transmitted through a transparent medium such as an optical fiber, and at the receiving end a photo detector may advantageously function as a receiver. In an IMDD system, the present modulation method may be labeled subcarrier modulation, as the generated electrical subcarrier signal is modulated first and then used to modulate the intensity of the optical carrier.

In an embodiment of the invention, the method may further comprise modulating a laser diode using the modulated electrical signal. Laser diodes of different kinds are commonly used in optical communication systems to provide the optical signal to be transmitted. Examples of laser diodes are pn-junction diodes, quantum well lasers, quantum cascade lasers, DFB lasers and vertical cavity surface emitting lasers (VCSELs). Other types of present and future suitable light generating devices, as well as all possible optical intensity modulators (such as Mach-Zehnder modulators, electro-absorption modulators or similar) are of course also possible and within the scope of the invention.

According to an embodiment, forming the modulated electrical signal may advantageously comprise pulse shaping said signal. Pulse shaping should be understood as changing the waveform of a signal by multiplying the signal with any finite-energy pulse shape determined by a selected function. As an example, the pulse shaping function may be a rectangular function. However, the pulse shaping function may equally well be any other function such as a Sinc function, raised cosine function, root-raised cosine function or a Gaussian function.

According to another aspect of the invention, there is provided a device for modulation, the device comprising: a data input for receiving a data stream; means for forming a modulated electrical signal from the data stream by using a plurality of data signals, each of the plurality of data signals representing at least one data bit of the data stream, wherein one of the plurality of data signals is a zero signal and wherein the remainder of the plurality of data signals comprises periodic, positive, non-zero subcarrier signals; and a signal output for providing the modulated electrical signal. Effects and features of this aspect of the present invention are largely analogous to those described above in connection with the previously discussed aspect. Alternatively or additionally the remainder of the plurality of data signals may comprise non-periodic signals with a positive DC-level.

Means for forming a modulated signal may comprise signal processing software or hardware adapted and configured to modulate an electrical signal.

According to still another aspect of the invention, it is provided a system for transferring a data stream, the system comprising a device for modulating a data stream, the device comprising: a data input for receiving said data stream; means for forming a modulated electrical signal from the data stream by using a plurality of data signals, each of the plurality of data signals representing at least one data bit of the data stream, wherein one of the plurality of data signals is a zero signal and wherein the remainder of the plurality of data signals comprises periodic, positive, non-zero subcarrier signals; and a signal output for providing the modulated electrical signal; a transmitter for modulating the modulated electrical signal onto an electromagnetic carrier; a transmission line; a receiver for receiving the modulated electromagnetic carrier and detecting its intensity; and a demodulator adapted for demodulating the modulated electrical signal, thereby recreating the data stream. As mentioned above, also in this case the effects and features are largely analogous to those described above in connection with the previously mentioned aspects. Alternatively or additionally the remainder of the plurality of data signals may comprise non-periodic signals with a positive DC-level.

In one embodiment of the invention, the transmission line may advantageously be an optical transmission line. An optical transmission line may be an optical fiber but it may also be other types of transmission lines such as optical wave guides suitable for use in short distance chip-to-chip or intra-chip communication systems. However, the transmission line may equally well be any electromagnetic communication link such as wired, radio, microwave, or free-space optical transmission.

According to one embodiment of the present invention, the transmitter may advantageously be a light generating device. However, the transmitter may equally well be any transmitter able to produce an amplitude modulated electromagnetic signal. In particular the light generating device may advantageously be a laser diode. Other types of light generating sources suitable for use in a communication system may also be used, for example other types of lasers or light emitting diodes.

According to an embodiment of the invention, the receiver can advantageously be a photodetector, for example a photodiode. The photodetector receives the transmitted light and translates the optical signal to an electrical signal. In a photodetector, the amplitude of the generated electrical signal is a function of the intensity of the received light.

According to still another aspect of the invention, it is provided a method for modulation, the method comprising: receiving a data stream; forming a modulated electrical signal from the data stream by using four data signals, each of the four data signals representing two data bits of the data stream, wherein one of the four data signals is a zero signal and the remaining three data signals are periodic, positive, non-zero subcarrier signals being equidistant in phase and having the same amplitude and DC-level; and providing the modulated electrical signal representing the data stream.

Advantages of this aspect are largely analogous with advantages discussed in relation to other aspects of the invention.

Further features of, and advantages with, the present invention will become apparent when studying the appended claims and the following description. The skilled addressee realize that different features of the present invention may be combined to create embodiments other than those described in the following, without departing from the scope of the present invention.

### BRIEF DESCRIPTION OF THE DRAWINGS

These and other aspects of the present invention will now be described in more detail with reference to the appended drawings showing exemplary embodiments of the invention, wherein:

FIG. 1 is a schematic view of a communication system according to the present invention;

FIG. 2 is a flow-chart schematically illustrating the modulation method according to the present invention;

FIG. 3 is a schematic representation of an exemplary set of data signals according to the present invention; and

FIG. 4 is a schematic illustration of an exemplary constellation diagram according to the present invention.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

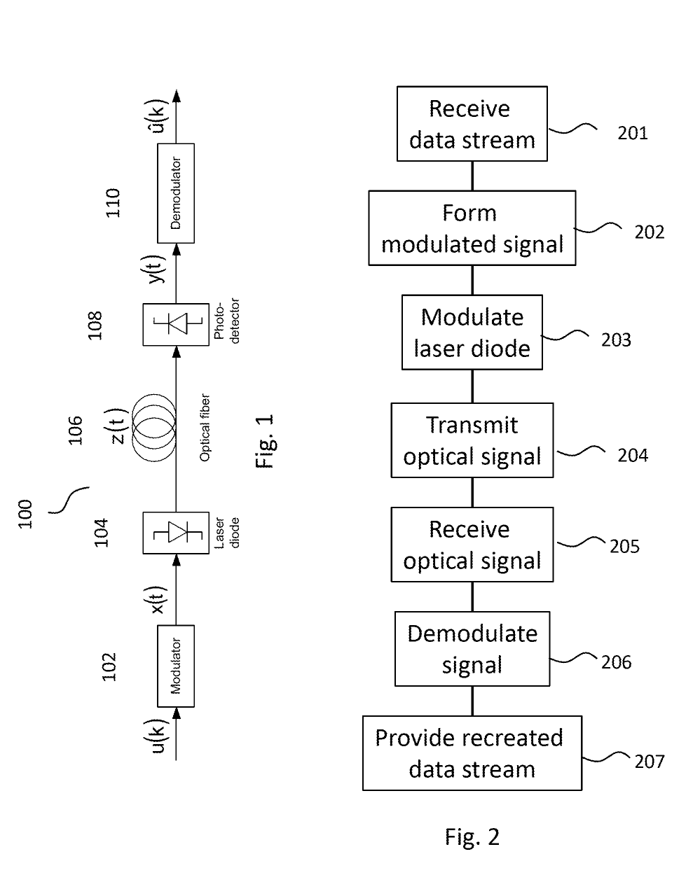

In the present detailed description, currently preferred embodiments of the method for modulation according to the present invention are mainly discussed with reference to a system transferring a data stream. An exemplary embodiment of the present invention will now be described with reference to FIG. 1 schematically illustrating a system 100 transferring a data stream together with the flow-chart shown in FIG. 2.

The system 100 shown in FIG. 1 comprises a modulator 102 for receiving and modulating a data stream, a laser diode 104 for converting the electrical signal to an optical signal, an optical fiber 106 for transferring the optical signal, a photo detector 108 for converting the optical signal to an electrical signal and demodulator 110 for receiving and demodulating the electrical signal, thereby recreating the data signal.

With reference to the flow chart shown in FIG. 2, during operation of the system 100, a digital data stream is received at the input of the modulator in a first step 201. In the following step 202, the data stream is read by the modulator. The modulator then maps the symbol u(k)ε{0, 1, . . . , M−1} at instant k to an electrical waveform belonging to the modulation signal set S={s₀(t), s₁(t), . . . , s_{M-1}(t)}. In the present context, a symbol represents one or more data bits, and each symbol is represented by a unique modulation signal.

In the next step, 203, the resulting positive electrical waveform x(t) is provided at the output at the modulator, directly modulating a laser diode connected to the modulator.

Next, 204, the laser diode is connected to an optical fiber, transmitting the modulated optical signal z(t). Thereafter, in step, 205, the transmitted optical signal is received by a photodetector, converting the optical signal to an electrical signal y(t). The photo detector is in turn connected to a demodulator. The following step 206 comprises demodulating the received signal, recreating the original data stream. Finally, in the final step, 207, the recreated data stream û(k) is provided at an output of the modulator.

The modulator 102 may be implemented using a type of generalized control unit. The control unit may in turn include a microprocessor, a microcontroller, a programmable digital signal processor or another programmable device. The control unit may also, or instead, include an application specific integrated circuit (ASIC), a programmable gate array programmable array logic, a programmable logic device, or a digital signal processor. Where the control unit includes a programmable device such as the microprocessor or microcontroller mentioned above, the processor may further include computer executable code that controls operation of the programmable device.

In general, an M-ary signal, with M=2ⁿ denoting the number of symbols and where n equals the number of bits per symbol can, according to the modulation scheme of the present invention, be represented by M signals as:

s₀(t)=0

sᵢ(t)=Aᵢp(t)[Bᵢ+sin(2πft+φᵢ], i⊂(1, . . . , M−1)

where p(t) is any finite-energy pulse shape and Aᵢ, Bᵢ, and φᵢ are suitably chosen constants for each data signal.

As a specific example, a 4-ary modulation format, wherein each data signal corresponds to a symbol representing two bits, will be described by the four signals:

$${s}_{0} ( t ) = 0$$

$${s}_{1} ( t ) = Ap ( t ) [ 1 \vert sin ( 2 π f t \vert ϕ ) ]$$

$${s}_{2} ( t ) = Ap ( t ) [ 1 + sin ( 2 π f t + \frac{2 π}{3} + ϕ ) ]$$

$${s}_{3} ( t ) = Ap ( t ) [ 1 + sin ( 2 π f t + \frac{4 π}{3} + ϕ ) ]$$

where f is the subcarrier frequency, A is an arbitrary constant, which scales the DC-level as well as the subcarrier amplitude, and φ is an arbitrary subcarrier phase. The signal s₀ can be mapped to correspond to the data bits 00, s₁ to 01, s₂ to 10 and s₃ to 11. Any other mapping of the four bit pairs (00, 01, 10, and 11) to the signals s₀, s₁, s₂ and s₃ can be also used.

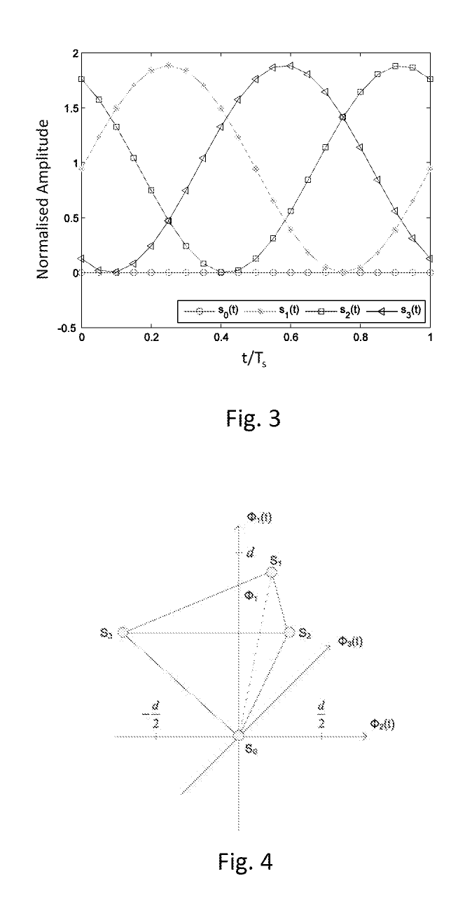

FIG. 3 schematically illustrates the four signals in a 4-ary modulation format as described above, for the special case when p(t) is a rectangular pulse in the range 0≦<Tₛ, where Tₛ is the symbol or signal time, f=1/Tₛ, and φ=0. Here, the amplitude as a function of time is shown and it can be seen that three signals are periodic and equidistant in phase and that the fourth signal is a zero-signal.

An analysis of the present modulation format in Euclidean space shows that the four signals can be represented in a 3-dimensional signal space. According to one embodiment of the invention, p(t) is a rectangular pulse in the range 0≦t<Tₛ and f=1/Tₛ, in which case the signal space has the basis vectors

$${ϕ}_{1} ( t ) = \frac{1}{\sqrt{{T}_{s}}}$$

$${ϕ}_{2} ( t ) = \sqrt{\frac{2}{{T}_{s}}} cos ( 2 π f t )$$

$${ϕ}_{3} ( t ) = \sqrt{\frac{2}{{T}_{s}}} sin ( 2 π f t ) ,$$

where 0≦t<Tₛ.

FIG. 4 shows the 3-dimensional constellation diagram of the 4-ary modulation scheme where the points s₀ to s₃ are located at the vertices of a regular tetrahedron.

The aforementioned four signals may be used as a basis in an extended modulation scheme where additional signals are introduced. Such additional signals may be different in subcarrier amplitude, phase, and DC-level. Additional data signals may also include non-periodic signals with different DC-level. The additional signals may advantageously have a higher DC-level than the four basis signals.

In conclusion, the presented modulation scheme offers better power efficiency than previously known modulation formats for intensity modulated direct detection communication systems.

Even though the invention has been described with reference to specific exemplifying embodiments thereof, many different alterations, modifications and the like will become apparent for those skilled in the art. Variations of the disclosed embodiments can be understood and effected by the skilled addressee in practicing the claimed invention, from a study of the drawings, the disclosure, and the appended claims. For example, even though the description above have been made in relation to a system for optical communication it is equally possible and within the scope of the invention to use the inventive concept in relation to any communication system using an intensity-modulated electromagnetic signal as an information carrier, such as such as wired, radio, microwave, or free-space optical transmission systems.

Furthermore, in the claims, the word “comprising” does not exclude other elements or steps, and the indefinite article “a” or “an” does not exclude a plurality.

1. Method for modulation, the method comprising:
receiving a data stream;
forming a modulated electrical signal from the data stream by using a plurality of data signals, each of the plurality of data signals representing at least one data bit of the data stream, wherein one of the plurality of data signals is a zero signal and the remainder of the plurality of data signals comprises periodic, positive, non-zero subcarrier signals; and
providing the modulated electrical signal representing the data stream.

2. Method according to claim 1, wherein the plurality of non-zero subcarrier signals comprises three signals and the phases of the signals are equidistantly spaced.

3. Method according to claim 2, wherein the three subcarrier signals being equidistant in phase all have the same amplitude.

4. Method according to claim 3, wherein the three subcarrier signals being equidistant in phase and having the same amplitude all have the same DC-level.

5. Method according to claim 1, wherein the plurality of subcarrier signals further comprises at least one non-periodic signal having a positive DC-level.

6. Method according to claim 1, wherein at least two of the non-zero subcarrier signals have different DC-levels.

7. Method according to claim 1, further comprising modulating a light generating device using the modulated electrical signal.

8. Method according to claim 1, further comprising modulating a laser diode using the modulated electrical signal.

9. Method according to claim 1, wherein forming the modulated electrical signal comprises pulse shaping said signal.

10. Device for modulation, the device comprising:
a data input for receiving a data stream;
means for forming a modulated electrical signal from the data stream by using a plurality of data signals, each of the plurality of data signals representing at least one data bit of the data stream, wherein one of the plurality of data signals is a zero signal and wherein the remainder of the plurality of data signals comprises periodic, positive, non-zero subcarrier signals and/or non-periodic signals with a positive DC-level; and
a signal output for providing the modulated electrical signal.

11. System for transferring a data stream, the system comprising
a device for modulating a data stream, the device comprising:
a data input for receiving said data stream;
means for forming a modulated electrical signal from the data stream by using a plurality of data signals, each of the plurality of data signals representing at least one data bit of the data stream, wherein one of the plurality of data signals is a zero signal and wherein the remainder of the plurality of data signals comprises periodic, positive, non-zero subcarrier signals and/or non-periodic signals with a positive DC-level; and
a signal output for providing the modulated electrical signal;
a transmitter for modulating the modulated electrical signal onto an electromagnetic carrier;
a transmission line;
a receiver for receiving the modulated electromagnetic carrier and detecting its intensity; and
a demodulator adapted for demodulating the modulated electrical signal, thereby recreating the data stream.

12. System according to claim 11, wherein the transmission line is an optical transmission line.

13. System according to claim 11, wherein the transmitter is a light generating device.

14. System according to claim 11, wherein the transmitter is a laser diode.

15. System according to claim 11, wherein the receiver is a photodetector.

16. Method for modulation, the method comprising:
receiving a data stream;
forming a modulated electrical signal from the data stream by using four data signals, each of the four data signals representing two data bits of the data stream, wherein one of the four data signals is a zero signal and the remaining three data signals are periodic, positive, non-zero subcarrier signals being equidistant in phase and having the same amplitude and DC-level; and
providing the modulated electrical signal representing the data stream.
